(19) United States
(12) Patent Application Publication
(10) Pub. No.: US 2019/0214623 A1
(43) Pub. Date: Jul. 11, 2019

(54) SEPARATION MEMBRANE-INTEGRATED ELECTRODE ASSEMBLY, METHOD OF MANUFACTURING THE SAME, AND LITHIUM ION SECONDARY BATTERY INCLUDING THE SAME

(71) Applicant: Samsung Electronics Co., Ltd., Suwon-si (KR)

(72) Inventors: Mitsuharu KIMURA, Kanagawa (JP); Ryo IWAMURO, Kanagawa (JP); Yoshitaka YAMAGUCHI, Kanagawa (JP); Hironari TAKASE, Kanagawa (JP)

(21) Appl. No.: 16/178,274

(22) Filed: Nov. 1, 2018

(30) Foreign Application Priority Data
Jan. 10, 2018 (KR) 10-2018-0003353

(51) Int. Cl. H01M 2/16; H01M 10/0525; H01M 4/13

(52) U.S. Cl. CPC H01M 2/1686; H01M 4/13; H01M 2/1673; H01M 10/0525

(57) ABSTRACT

A separation membrane-integrated electrode assembly for a lithium ion secondary battery comprising an electrode active material layer; and a separation membrane on the electrode active material layer, wherein the separation membrane comprises cellulose nanofibers and a polymer as a binder, and the polymer contains a reactive group that forms a hydrogen bond with the cellulose nanofibers, as well as a method of manufacturing the separation membrane-integrated electrode assembly, and a lithium ion secondary battery including the separation membrane-integrated electrode assembly.

### CROSS-REFERENCE TO RELATED APPLICATIONS

This application claims the benefit of Japanese Patent Application No. 2017-211979, filed on Nov. 1, 2017, in the Japanese Patent Office and Korean Patent Application No. 10-2018-0003353, filed on Jan. 10, 2018, in the Korean Intellectual Property Office, the entire disclosures of which are hereby incorporated by reference.

### BACKGROUND

### 1. Field

The present disclosure relates to a separation membrane-integrated electrode assembly, a method of manufacturing the separation membrane-integrated electrode assembly, and a lithium ion secondary battery including the separation membrane-integrated electrode assembly.

### 2. Description of the Related Art

In the manufacture of a lithium ion secondary battery, a separation membrane composed of an insulator is used to electrically separate a cathode and an anode from each other. An example of a separation membrane is a microporous membrane that may be obtained by extrusion of a polyethylene resin while stretching the resin in one direction, for example, a machine direction (MD, lateral direction) or a traverse direction (TD, longitudinal direction), or both a TD and an MD. However, when the temperature rises during battery use, a microporous membrane processed through such stretching may undergo relaxation of residual stretching stress.

Additionally, change in temperature may further result in thermal shrinkage of the polyethylene film, thereby causing a change in the dimensions of a large separation membrane. When a change in the dimensions of a separation membrane occurs, a short circuit may occur inside the battery, consequently generating a large amount of heat.

Another example of a separation membrane is an electrode-integrated separation membrane having a fine-particle layer formed on an electrode active material layer. The fine-particle layer uses polyethylene particles as fine-particle fillers.

Additionally, there has been an increasing demand to develop a battery having increased distance per drive in an electric vehicle mode (EV-mode) and rapid charging capabilities (e.g., charging in 30 minutes). Accordingly, a lithium ion secondary battery for vehicles has been developed to achieve a single battery having high energy density, high capacity, and a battery structure having low internal resistance.

However, in order to obtain a high-density electrode, the coating amount of the electrode material must be increased in order to increase the applied amount of the active material. The increase in coating generally causes the electrode to be thick and hard, such that the battery manufacturing process of winding the electrode together with a separation membrane has been replaced by alternatively stacking a single electrode and a separation membrane on one another.

However, seaming that is achieved when the electrode and the separation membrane are wound together may not be achieved with the stacking method, such that a gap between the electrode and the separation membrane may be generated, thereby increasing internal resistance of the battery and deteriorating load characteristics or lifetime characteristics of the battery.

In the stacking method, the electrode and the separation membrane are merely stacked on one another. Accordingly, the stacking positions of the electrode and the separation membrane may be altered while proceeding to a subsequent process. To prevent this, the separation membrane may be adhered to the electrode by applying a thermoplastic binder to the inside and outside of the separation membrane. However, this method involves hot pressing at a heating temperature above 100° C., such that micropores on the inside and outside of the separation membrane formed of a stretched film of polyethylene resin may become clogged.

Accordingly, there exists a need for a new separation membrane-integrated electrode assembly and method of manufacturing said assembly.

### SUMMARY

Provided herein is a separation membrane-integrated electrode assembly having high thermal resistance, and a method of manufacturing the separation membrane-integrated electrode assembly.

Provided herein is a lithium ion secondary battery including the separation membrane-integrated electrode assembly.

Provided herein is a separation membrane-integrated electrode assembly for a lithium ion secondary battery that includes an electrode active material layer and a separation membrane on the electrode active material layer, wherein the separation membrane includes cellulose nanofibers and a water-soluble or water-dispersible polymer.

Also provided is a lithium ion secondary battery that includes the separation membrane-integrated electrode assembly.

The disclosure further provides a method of manufacturing a separation membrane-integrated electrode assembly for a lithium ion secondary battery, which method includes: coating an electrode active material layer with a composition that is obtained by mixing cellulose nanofibers, an aqueous polymer, a water-soluble organic solvent, and water, to thereby form a separation membrane; and drying the separation membrane.

In some embodiments, the separation membrane may comprise about 80 parts by weight to about 99 parts by weight cellulose nanofibers based on 100 parts by weight of the total weight of the separation membrane (e.g., about 80 wt. % to about 90 wt. %), and the cellulose nanofibers may have an average fiber diameter of about 10 nm to about 2000 nm. The cellulose nanofibers may include less than about 20 wt % of fibers having an average fiber diameter of about 1000 nm or greater. A porous insulating layer may further be provided between the separation membrane and the electrode active material layer.

In some embodiments, the method may further include, before the forming of the separation membrane, forming a porous insulating layer on the electrode active material layer, the porous insulating layer including a heat-resistant filler as a main component.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view illustrating a structure of a separation membrane-integrated electrode assembly for a lithium ion secondary battery, according to an embodiment;

FIG. 2 is a graph illustrating rapid charge/discharge cycle characteristics of lithium ion secondary batteries according to Examples 1 to 7 and Comparative Example 1;

FIG. 3 is a scanning electron microscope (SEM) image of a cross-sectional structure of a separation membrane-integrated electrode assembly in the lithium ion secondary battery of Example 1, as a result of Evaluation Example 1; and

FIG. 4 is a magnified SEM image of a separation membrane region of a separation membrane-integrated electrode assembly in the lithium ion secondary battery of Example 1, as a result of Evaluation Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the invention. As used herein, the term “and/or” includes any and all combinations of one or more of the associated listed items. Expressions such as “at least one of,” when preceding a list of elements, modify the entire list of elements and do not modify the individual elements of the list. The following description of embodiments should be considered in a descriptive sense only and not for the purposes of limiting applicable objects or uses.

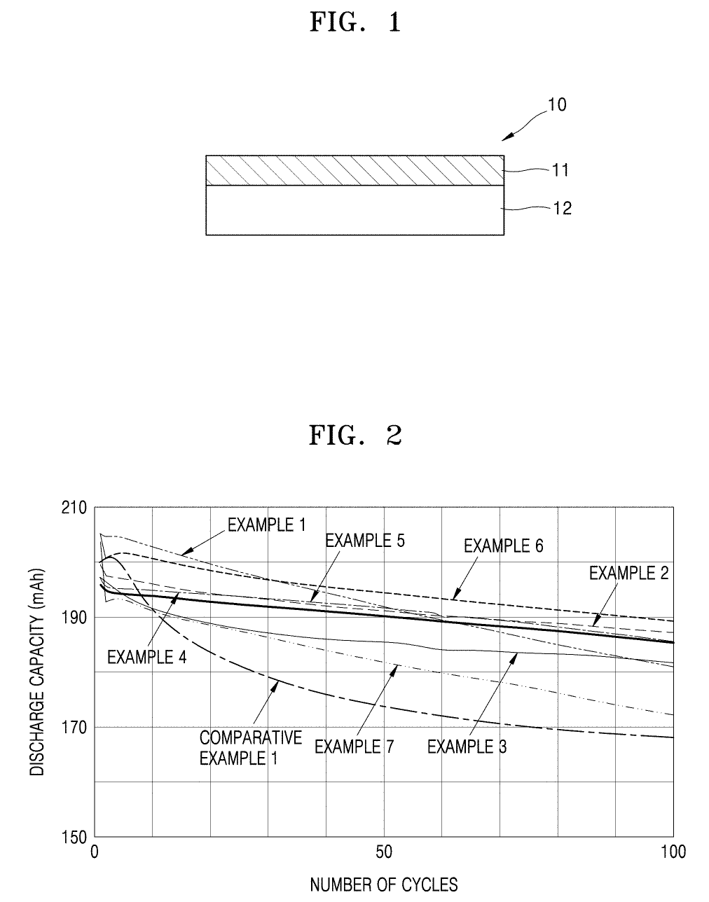

Referring to FIG. 1, a separation membrane-integrated electrode assembly (10) according to an embodiment has a structure in which a separation membrane 12 including cellulose nanofibers and a polymer as a binder may be on an electrode active material layer 12 that constitutes an electrode. This structure is merely illustrative, and, the separation membrane-integrated electrode assembly 10 also may include additional elements, such as an electrode current collector included together with the electrode material layer 11.

The polymer can be a water soluble or water-dispersible polymer, also referred to as an aqueous polymer. Water-soluble, water-dispersible, or aqueous polymers include polymers that are soluble or dispersible in water. Such a polymer contains a functional group that may react with surface functional groups of cellulose nanofibers that participate in hydrogen bonding, and, thus, inhibit hydrogen bond formation between the cellulose nanofibers.

The amount of the polymer (e.g., aqueous polymer) may be about 0.1 parts to about 20 parts by weight based on 100 parts by weight of the cellulose nanofibers. A mixed weight ratio of the aqueous polymer used as a binder to the cellulose nanofibers may be, for example, about 100:0.5 to about 100:2. In one embodiment, the weight ratios are based on the dried membrane.

The separation membrane has high heat-resistance, such that the separation membrane may be utilized in a separation membrane-integrated electrode assembly suitable for a stacked battery. The electrode may be, for example, an anode or cathode.

One embodiment of the electrode active material that forms the electrode active material layer will be described as follows.

<Electrode Active Material>

Electrode active material may refer to a cathode active material or an anode active material.

A cathode-active material of a cathode according to an embodiment may be any active material for the cathode of a lithium ion secondary battery. Examples of the active materials used for the cathode of the lithium ion secondary battery may include lithium-containing metal oxides such as a lithium cobalt oxide, a lithium manganese oxide, and a lithium iron phosphate. However, embodiments are not limited thereto.

An anode active material of an anode according to an embodiment may be any active material for the anode of a lithium ion secondary battery. Examples of the active material used for the anode of the lithium secondary battery may include a carbonaceous material such as graphite, a silicon material, and the like. However, embodiments are not limited thereto.

<Cellulose Nanofibers>

The separation membrane includes cellulose nanofibers. Examples of cellulose as a raw material that forms the cellulose nanofibers are not specifically limited, and may include, for example, natural cellulose that is separated and purified through biosynthesis from plants, animals, or bacteria-produced gels. For example, the cellulose may be from softwood pulp, hardwood pulp, cottonwood pulp such as cotton linter, non-wood pulp such as straw pulp or bagasse pulp, bacterial cellulose, cellulose isolated from Ascidiacea, or cellulose isolated from seaweed.

In some embodiments, the cellulose nanofibers may have an average fiber diameter of about 10 nm to about 2000 nm, wherein “average fiber diameter” is the number-average fiber diameter. In some embodiments, when the cellulose nanofibers have an average fiber diameter within this range, air permeability of the separation membrane is maintained and does not deteriorate as compared to other membranes.

In some embodiments, the separation does not include fibers having an average fiber diameter of about 1000 nm or greater.

In some embodiments, less than about 20 wt. % of the fibers have a fiber diameter of about 1000 nm or greater. For example, in some embodiments, about 80 wt % or more, about 95 wt % or more, or even about 95 wt % or more, such as about 99 wt % or more of the cellulose nanofibers have an average fiber diameter of less than 1000 nm. In additional embodiments, about 80 wt % or more of the cellulose nanofibers have an average fiber diameter of about 500 nm or less. Without wishing to be bound by any theory or mechanism of action, it is believed that reducing a proportion of the fibers having a large diameter in the cellulose nanofibers may make it easier to control the thickness, micropore diameter, and air permeability of the separation membrane during separation membrane formation.

In some embodiments, the amount of cellulose nanofibers in the separation membrane may be about 80 parts by weight to about 99 parts by weight cellulose nanofibers based on 100 parts by weight of the total weight of the separation membrane (e.g., about 80 wt. % to about 90 wt. %). When the amount of the cellulose nanofibers in the separation membrane is within this range, the separation membrane may have improved mechanical strength without reduction in ion conductivity.

A fiber diameter may be measured by transmission electron microscopy (TEM) or scanning electron microscopy (SEM) by observing the separation membrane. Fiber diameter may also be measured by TEM or SEM by using a film obtained by casting a dilute solution of the cellulose nanofibers and drying a product of the casting. A ratio of the fibers having a fiber diameter of less than 1000 nm may be obtained through comprehensive evaluations of a viscosity of an aqueous dispersion of the cellulose nanofibers of less than about 0.1 wt % to about 2 wt % (measured using an E type or B type viscometer), tensile strength, and specific surface area of the porous film. For example, this may be referred to International Patent WO 2013/054884.

<Aqueous Polymer as a Binder>

The aqueous (e.g., water-soluble or water-dispersible) polymer according to one or more embodiments may be used as a material that forms the separation membrane together with the cellulose nanofibers. The solubility in water of the aqueous polymer is dependent on temperature and concentration. In addition, for example, when the aqueous polymer as a powder is added to water and stirred, the surface of the aqueous polymer powder may be partially dissolved under certain dissolution conditions and dispersed in the water.

When a solution of the aqueous polymer dissolved in an organic solvent is diluted with the water-soluble organic solvent, a dilute solution having about a 0.5-3.0 wt % solid content of the aqueous polymer may be used.

The aqueous polymer may be coated on a surface of the cellulose nanofibers. The polymer comprises a reactive group that forms a hydrogen bond with the surface of the cellulose nanofiber. As a result of the polymer coating, strong hydrogen bonding between the cellulose nanofibers may be inhibited, and mechanical strength of the separation membrane, such as elongation at break, may be improved.

The aqueous polymer may be any suitable water-soluble or water-dispersible polymer. For example, the aqueous polymer may be at least one polymer selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide; a copolymer including at least two selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide; or a mixture of at least one polymer selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide, with at least one of the above-listed copolymers. In other words, the aqueous polymer as a binder may be one of three materials, i.e., “at least one selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide,” “a copolymer including at least two selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide,” and “a mixture of at least one selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide, with at least one of the above-listed copolymers.” In one embodiment, the polymer has a main chain containing a hydroxyl group. The polymer may also have a side chain containing at least one selected from a hydroxyl group, —CO, —COO, —COOH, —CN, and —NH₂, or a combination thereof.

As used herein, a “copolymer including at least two selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide” may refer to a copolymer obtained by copolymerization of at least two monomers selected from monomers forming the above-listed polymers.

In some embodiments, the aqueous polymer may have a weight average molecular weight of about 1,000 g/mol or more. In further embodiments the aqueous polymer may have an average molecular weight of about 2,000 g/mol to about 600,000 g/mol. In additional embodiments, the aqueous polymer may have an average molecular weight of about 2,000 g/mol to about 400,000 g/mol.

<Water-Soluble Organic Solvent>

The separation membrane according to one or more embodiments of the present disclosure may be a coated membrane on the electrode active material layer. Accordingly, the separation membrane may be formed by coating a composition including the cellulose nanofibers, the aqueous polymer, and a water-soluble organic solvent as described above on the electrode active material layer. The composition may be an aqueous dispersion of the cellulose nanofiber, the aqueous polymer, and the water-soluble organic solvent. The composition may be an aqueous suspension of the cellulose nanofiber, the aqueous polymer, and the water-soluble organic solvent.

The water-soluble organic solvent may function as a water-soluble pore former, and may form a plurality of pores in the membrane resulting from the drying of the composition to remove the water-soluble organic solvent.

The water-soluble organic solvent functioning as a water-soluble pore former may be any organic solvent commonly used in the art. For example, the water-soluble organic solvent may be at least one organic solvent selected from an alcohol-based organic solvent (an organic solvent containing alcohol groups), a lactone-based organic solvent (an organic solvent comprising lactone groups), a glycol-based organic solvent (an organic solvent comprising glycol groups), a glycol ether-based organic solvent (an organic solvent comprising glycol ether groups), glycerin, a carbonate-based organic solvent (an organic solvent comprising carbonate groups), and N-methylpyrrolidone. The alcohol-based organic solvent may be, for example, 1,5-pentanediol, 1-methylamino-2,3-propanediol, or the like. The lactone-based organic solvent may be, for example, ε-caprolactone, α-acetyl-γ-butyrolactone, or the like. The glycol-based organic solvent may be, for example, diethylene glycol, 1,3-butylene glycol, propylene glycol, or the like. The glycol ether-based organic solvent may be, for example, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, diethylene glycol diethyl ether, or the like. The carbonate-based organic solvent may be, for example, propylene carbonate, ethylene carbonate, or the like. In some embodiments, the water-soluble organic solvent may be triethylene glycol butyl methyl ether.

In some embodiments, the water-soluble organic solvent may include at least one of a glycol ether such as triethylene glycol butyl methyl ether, a 1^{st} or 2^{nd} grade alcohol having 1 to 3 carbon atoms, ethylene carbonate, and propylene carbonate.

<Porous Insulating Layer>

The porous insulating layer may include a heat-resistant filler as a main component. This means that the porous insulating layer may include about 60 wt % or more of the heat-resistant filler in the insulating layer.

The heat-resistant filler may be, for example, inorganic particles or heat-resistant organic particles. The heat-resistant filler may be, for example, inorganic fine particles or heat-resistant organic fine particles.

The heat-resistant filler may be any organic or inorganic filler which is chemically stable in a non-aqueous liquid electrolyte. In view of battery safety, inorganic particles that are stable at a temperature of about 150° C. or heat-resistant organic particles may be used as the heat-resistant filler.

The inorganic particles may be, for example, a metal hydroxide, a metal oxide, a metal carbonate, a metal sulfate, a clay mineral, or a combination thereof. Non-limiting examples of the metal hydroxide are aluminum hydroxide, magnesium hydroxide, calcium hydroxide, chromium hydroxide, zirconium hydroxide, nickel hydroxide, and boron hydroxide. Non-limiting examples of the metal oxide are alumina and zirconium oxide. Non-limiting examples of the metal carbonate are calcium carbonate and magnesium carbonate. Non-limiting examples of the metal sulfate are barium sulfate and calcium sulfate. Non-limiting examples of the clay mineral are calcium silicate and talc. In some embodiments of the present disclosure, the above-listed metal hydroxides that provide good flame retardant or anti-electrostatic effect may be used. The particles of the filler may have any shape, such as spherical, elliptical, planar, rod-like, or other, irregular shapes. In one embodiment, the particles of the filler may be planar or unaggregated primary particles.

The heat-resistant organic particles may be, for example, crosslinked polymer particles, heat-resistant polymer particles, or a combination thereof. The crosslinked polymer particles may be, for example, crosslinked polyacrylic acid, crosslinked polyacrylic acid ester, crosslinked polymethacrylic acid, crosslinked polymethacrylic acid ester, crosslinked polymethyl methacrylate, crosslinked polysilicon, crosslinked polystyrene, crosslinked polydivinylbenzene, a crosslinked styrene-divinylbenzene copolymer, polyimide, melamine resin, phenol resin, a benzoguanamine formaldehyde condensate, or the like. The heat-resistant polymer particles may be, for example, polysulfone, polyacrylonitrile, polyaramid, polyacetal, thermoplastic polyimide, or the like.

A polymer that constitutes the heat-resistant organic filler may be a mixture, a modified product, a derivative, a copolymer (for example, a random copolymer, an alternating copolymer, a block copolymer, and a graft copolymer), or a cross-linked product of the above-listed molecular species.

The above-listed various fillers may be used alone or in a combination.

The inorganic particles or the heat-resistant organic particles may have an average particle diameter of about 0.01 μm to about 1 μm, and in some embodiments, about 0.02 μm to about 1 μm, or about 0.05 μm to about 1 μm. Having inorganic or organic particles with an average particle diameter within these ranges may ensure that the porous insulating layer has improved adhesion to the electrode active material layer, surface evenness, and suitable pores that form ion diffusion paths.

The average particle diameter of the particles refers to a particle diameter (median particle diameter, D50) at a point where a cumulative particle diameter distribution reaches 50 vol. % with respect to a total volume of the particles. The median particle diameter (D50) is an average particle diameter that may be measured using water as a dispersion medium with a laser diffraction particle size distribution analyzer (Mastersizer 2000, Sysmax).

In some embodiments, the porous insulating layer may be disposed between the electrode and the separation membrane comprising the cellulose nanofibers. In some embodiments, the heat-resistant filler is the main component of the porous insulating layer. The heat-resistant filler may be the inorganic particles or heat-resistant organic particles detailed above.

The inorganic particles may be, for example, high-purity alumina (AKP-3000, Sumitomo Chemicals).

The heat-resistant organic particles may be, for example, a crosslinked acrylic monodisperse particle (MX-80 H3wT, Soken Chemical Co.).

The porous insulating layer may have a thickness of about 10 m or less, and in some embodiments, about 1 to about 3 μm. These ranges may help the lithium ion battery achieve rapid charging capability.

<Separation Membrane-Integrated Electrode Assembly Manufacturing Method>

In one embodiment, the method of manufacturing the separation membrane-integrated electrode assembly may include: a process of forming a separation membrane by applying, onto an electrode active material layer, a suspension comprising cellulose nanofibers, an aqueous polymer as a binder, and a water-soluble organic solvent dispersed in water; and a process of drying the separation membrane. To improve safety performance of a battery, the method may further include a process of forming a porous insulating layer between the electrode active material layer and the separation membrane. The method also may include a step of forming or otherwise providing an electrode active material layer.

<Electrode Active Material Layer Formation Process>

In one embodiment of the present disclosure, an active material layer of an anode may be formed using natural graphite or artificial graphite, or a mixture thereof as an electrode active material, a styrene-butadiene copolymer latex as an electrode binder, a conducting agent which facilitates electron conductivity, and carboxymethylcellulose sodium salt that may improve dispersibility of these ingredients in an aqueous solvent (e.g. water). These components may be dispersed in an aqueous solvent, such as water, to provide a slurry mixture. This slurry mixture may be coated on a copper foil as a current collector (e.g., using a suitable applicator), and the resulting product may be subjected to a drying process to remove the aqueous solvent, thereby forming the electrode active material layer. Although the electrode active material layer of the anode is described herein, the electrode active material layer according to one or more embodiments may be an active material layer of either a cathode or anode. The thickness of the electrode active material layer is not specifically limited. In some embodiments, the electrode active material layer may have a porous insulating layer formed thereon.

<Porous Insulating Layer Formation Process>

The porous insulating layer can be prepared by first preparing a composition of a heat-resistant filler of a certain concentration. This composition may be, for example, a suspension. A solvent that may be used to prepare the suspension may be a mixed solution of water and a water-soluble organic solvent, as used in the separation membrane formation process. A binder such as that described in the separation membrane formation process set out below may be added to the suspension.

Subsequently, the prepared suspension may be coated on the electrode active material layer. The coating may be performed by any suitable method, such as by using, for example, a comma coater, a roll coater, a reverse roll coater, a direct gravure coater, a reverse gravure coater, an offset gravure coater, a roll kiss coater, a reverse kiss coater, a micro gravure coater, an air doctor coater, a knife coater, a bar coater, a wire bar coater, a die coater, a dip coater, a blade coater, a brush coater, a curtain coater, a die slot coater, or a cast coater. One of these methods or a combination of at least two thereof may be used. Coating processes using these coaters may be performed in a batch or continuous manner.

The heat-resistant filler suspension coated on the electrode active layer may then be dried to thereby form a porous insulating layer including pores formed by gaps between deposited heat-resistant filler particles.

The drying may be performed by, for example, hot-air drying, infrared drying, hot-plate drying, vacuum drying, or the like.

<Separation Membrane Formation Process>

First, a composition of the cellulose nanofibers of a certain concentration may be prepared. This composition may be prepared as, for example, an aqueous suspension.

Additionally, an aqueous polymer may be used as a binder, and subsequently added to the prepared aqueous suspension of the cellulose nanofibers to thereby prepare a mixed suspension. The aqueous polymer may be any aqueous polymer described herein, and may be the same polymer as used in the porous insulating layer when present.

In one embodiment of the present disclosure, the surface of the cellulose nanofibers is coated with a polymer binder that comprises a reactive group that forms a hydrogen bond with the surface of the cellulose nanofiber, hydrogen bonding between the cellulose nanofibers may be inhibited In addition, the formation of hydrogen bonds between fibers may also be inhibited by hydroxyl groups that are present on the surface of the cellulose nanofibers. Accordingly, strong bonding via numerous hydrogen bonds present on the surface of the cellulose nanofibers may be inhibited, and mechanical strength (elongation at break) of the separation membrane may be improved.

The amount of the aqueous polymer used may be about 0.1 wt % to about 20 wt %, for example, about 0.5 wt % to about 2 wt % based on a total weight of the cellulose nanofibers and the aqueous polymer.

The concentration of the cellulose nanofibers in the mixed suspension will be selected based on the desired end concentration of fibers in the separation membrane. In some embodiments, the concentration of cellulose nanofibers used is sufficient to provide a separation membrane with about 80 parts by weight to about 99 parts by weight cellulose nanofibers based on 100 parts by weight of the total weight of the separation membrane.

The suspension can comprise any suitable solvent. In one embodiment, the solvent of the suspension may be water. In other embodiments, a solvent having a higher vapor pressure than water may be used in combination with or instead of water.

Subsequently, a water-soluble organic solvent as described above may be added to the mixed suspension to adjust the concentration of the mixed suspension. The amount of the water-soluble organic solvent added to the suspension may be adjusted according to desired characteristics of the separation membrane. The amount of the water-soluble organic solvent may be about 5 parts by weight or more, and in some embodiments, about 50 parts by weight or more, and in further embodiments, about 100 parts by weight or more, and in other embodiments, about 100 parts to about 3000 parts by weight, and in additional embodiments, about 100 parts to about 1000 parts by weight, each with respect to 100 parts by weight of the cellulose nanofibers.

The binder may be added before or after the water-soluble organic solvent. For example, in one embodiment, the binder is added after the water-soluble organic solvent is added to the aqueous suspension of the cellulose nanofiber.

Subsequently, the mixed suspension may be coated on the electrode active material layer. When the electrode active material layer has a porous insulating layer on the surface thereof, the mixed suspension may be coated on the porous insulating layer. For example, the coating may be performed by using a comma coater, a roll coater, a reverse roll coater, a direct gravure coater, a reverse gravure coater, an offset gravure coater, a roll kiss coater, a reverse kiss coater, a micro gravure coater, an air doctor coater, a knife coater, a bar coater, a wire bar coater, a die coater, a dip coater, a blade coater, a brush coater, a curtain coater, a die slot coater, or a cast coater. One of these methods or a combination of at least two thereof may be used. Coating processes using these coaters may be performed in a batch or continuous manner. In some embodiments, a surface of the electrode active material layer may be treated by fluorine coating, corona treatment, plasma treatment, UV treatment, or anchor coating prior to coating with the cellulose nanofiber suspension or, when present, the porous insulating layer. It is believed that such treatment improves adhesion to the electrode active material layer.

<Separation Membrane Drying Process>

The suspension coated on the electrode active material layer may be dried to thereby form the separation membrane. For example, the drying may be performed using hot-air drying, infrared drying, hot-plate drying, or vacuum drying. The separation membrane may be a nonwoven fabric comprising the cellulose nanofibers as a main component.

In some embodiments, the drying may be performed at a temperature of about 50° C. or higher, for example, about 60° C. or higher. The drying may also be performed at a temperature of about 200° C. or lower, and in some embodiments, about 150° C. or lower, and in other embodiments, about 120° C. or lower, in order to prevent deterioration of the cellulose nanofibers.

In some embodiments, after the water and the water-soluble organic solvent in the coated suspension are removed by evaporation to form the separation membrane on the electrode active layer, the obtained separation membrane may be washed with, for example, an organic solvent. The organic solvent is not specifically limited. The organic solvent may be an organic solvent having a relatively high volatilization rate, for example, toluene, acetone, methyl ethyl ketone, ethyl acetate, n-hexane, or propanol. These organic solvents may be used alone or in a combination of at least two thereof. The organic solvent may be used at once or several times. The washing may reduce and/or remove the remaining water-soluble organic solvent from the coated suspension.

In some embodiments, an organic solvent having high affinity with water, such as ethanol or methanol, may be used. However, these solvents may absorb moisture in the water and affect physical properties or a sheet shape of the separation membrane. Accordingly, these solvents may be used under controlled humidity. A solvent having high hydrophobicity such as n-hexane or toluene may also be used because it has a low hygroscopic property.

In some embodiments, the washing may be repeated with sequential substitution of solvents in the order of increasing hydrophobicity. For example, the washing may be performed using acetone, toluene, and then n-hexane in the stated order.

In some embodiments, a pressing treatment may then be performed on the stacked structure of the electrode active material layer and the separation membrane (and porous insulating layer when present). In other embodiments, the pressing treatment is not performed.

The pressing treatment is not specifically limited in terms of treatment temperature and pressure. For example, the pressing treatment may be performed at a temperature of about 100° C. to about 150° C., for example, about 110° C. to about 130° C., at a pressure of about 0.3 MPa to about 5 MPa, for example, about 0.5 MPa to about 1.5 MPa, for about 0.1 minutes to about 30 minutes, for example, about 1 minute to about 8 minutes.

Through the above-described processes, the separation membrane-integrated electrode assembly according to the one or more embodiments may be obtained. The separation membrane-integrated electrode according to the one or more embodiments may have improved adhesion between the separation membrane and the electrode. However, when the binder is not added, the adhesion between the electrode active material layer and the separation membrane may be reduced even when the pressing treatment is performed.

Hereinafter, embodiments of a lithium ion secondary battery including the separation membrane-integrated electrode assembly according to the one or more embodiments and a method of manufacturing the lithium ion secondary battery will be described in detail.

The shape of the lithium ion secondary battery according to one or more embodiments is not specifically limited. For example, the lithium ion secondary battery may be a jelly roll type, a stack type, a stack folding type, or a lamination-stack type.

The lithium ion secondary battery according to one or more embodiments may be manufactured by encasing a battery assembly including the separation membrane-integrated electrode assembly according to the one or more embodiments in a battery case together with a liquid electrolyte. The separation membrane-integrated electrode assembly may be, for example, a separation membrane-integrated anode assembly.

In a separation membrane-integrated anode assembly according to an embodiment, the battery assembly may have a structure in which a cathode and the separation membrane are stacked or wound together.

The lithium ion secondary battery according to one or more embodiments may be, for example, a stacked battery. For example, the lithium ion secondary battery may be a lithium polymer battery, a lithium sulfur battery, or a lithium air battery.

In one embodiment of the present disclosure, an anode may be manufactured according to the following method.

For example, an anode active material, a conducting agent, a binder, and a solvent may be mixed to prepare an anode active material composition. The anode active material composition may be directly coated on a current collector, such as a copper foil, and subsequently dried, thereby manufacturing an anode. In additional embodiments, the anode active material composition may be cast on a separate support to form an anode active material film. This anode active material film may then be separated from the support and laminated on a current collector such as a copper foil to thereby manufacture an anode. The anode may have any shape.

In some embodiments, the anode active material may be any anode active material for a lithium battery available in the art. For example, the anode active material may include at least one selected from lithium metal, a metal alloyable with lithium, a transition metal oxide, a non-transition metal oxide, and a carbonaceous material.

Examples of the metal alloyable with lithium are Si, Sn, Al, Ge, Pb, Bi, Sb, a Si—Y alloy (wherein Y may be an alkali metal, an alkali earth metal, a Group 13 element, a Group 14 element, a transition metal, a rare earth element, or a combination thereof, and Y is not Si), and a Sn—Y alloy (wherein Y may be an alkali metal, an alkali earth metal, a Group 3 element, a Group 14 element, a transition metal, a rare earth element, or a combination thereof, and Y is not Sn). In some embodiments, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

Examples of the transition metal oxide may be a lithium titanium oxide, a vanadium oxide, and a lithium vanadium oxide.

Examples of the non-transition metal oxide may be SnO₂ and SiOₓ (wherein 0<x<2).

Examples of the carbonaceous material include crystalline carbon, amorphous carbon, or mixtures thereof. Examples of the crystalline carbon may be graphite, such as natural graphite or artificial graphite, in amorphous, plate, flake, spherical, or fibrous form. Examples of the amorphous carbon may be soft carbon (carbon sintered at low temperatures), hard carbon, meso-phase pitch carbides, and sintered cokes.

Examples of the conducting agent may be natural graphite, artificial graphite, carbon black, acetylene black, or Ketjen black; carbon fibers; or metal powder or metal fibers of copper, nickel, aluminum or silver. In some embodiments, a conducting material such as a polyphenylene derivative or a mixture including a conducting material may be used. However, embodiments are not limited thereto, and any material available as a conducting material in the art may be used. In addition, any of the crystalline materials described herein may be further added as a conducting material.

Examples of the binder may include a vinylidene fluoride/hexafluoropropylene copolymer, polyvinylidene fluoride (PVDF), polyacrylonitrile, polymethyl methacrylate, polytetrafluoroethylene, and mixtures thereof. A styrene-butadiene rubber polymer may be further used as a binder. However, embodiments are not limited thereto, and any material available as a binder in the art may be further used.

Examples of the solvent may be N-methylpyrrolidone, acetone, and water. However, embodiments are not limited thereto, and any material available as a solvent in the art may be used.

The amounts of the anode active material, the conducting agent, the binder, and the solvent may be in ranges commonly used in lithium batteries. At least one of the conducting agent, the binder, and the solvent may be omitted according to a use and a structure of the lithium battery.

Next, a cathode may be manufactured according to the following method.

The cathode may be prepared in the same manner as the anode, except that a cathode active material is used instead of an anode active material. A cathode active composition may include a conducting agent, a binder and a solvent that may be the same as those used in the manufacturing of the anode.

For example, a cathode active material, a conducting agent, a binder, and a solvent may be mixed together to prepare a cathode active material composition. The cathode active material composition may be directly coated on an aluminum current collector to thereby manufacture a cathode. In some embodiments, the cathode active material composition may be cast on a separate support to form a cathode active material film. This cathode active material film may then be separated from the support and laminated on an aluminum current collector to thereby manufacture a cathode. The cathode is not limited to the above-listed forms, and may be any of a variety of types.

In some embodiments, the cathode active material may include at least one selected from a lithium cobalt oxide, a lithium nickel cobalt manganese oxide, a lithium nickel cobalt aluminum oxide, a lithium iron phosphate, and a lithium manganese oxide. However, embodiments are not limited thereto. Any material available as a cathode active material in the art may be used.

For example, the cathode active material may be a compound represented by one of the following formulae: LiₐA_{1-b}B_{b}D₂ (wherein 0.90≤a≤1.8 and 0≤b≤0.5); LiₐE_{1-b}B_{b}O_{2-c}D_{c} (wherein 0.90≤a≤1.8, 0≤b≤0.5, and 0≤c≤0.05); LiE_{2-b}B_{b}O_{4-c}D_{c} (wherein 0≤b≤0.5, and 0≤c≤0.05); LiₐNi_{1-b-c}Co_{b}B_{c}Dₐ (wherein 0.90≤a≤1.8, 0≤b≤0.5, 0≤c≤0.05, and 0<α≤2); LiₐNi_{1-b-c}Co_{b}B_{c}O₂₋ₐFₐ (wherein 0.90≤a≤1.8, 0≤b≤0.5, 0≤c≤0.05, and 0<α<2); LiₐNi_{1-b-c}Co_{b}B_{c}O₂₋ₐF₂ (wherein 0.90≤a≤1.8, 0≤b≤0.5, 0≤c≤0.05, and 0<α<2); LiₐNi_{1-b-c}Mn_{b}B_{c}Dₐ (wherein 0.90≤a≤1.8, 0≤b≤0.5, 0≤c≤0.05, and 0<α<2); LiₐNi_{1-b-c}Mn_{b}B_{c}O₂₋ₐFₐ (wherein 0.90≤a≤1.8, 0≤b≤0.5, 0≤c≤0.05, and 0<α<2); LiₐNi_{1-b-c}Mn_{b}B_{c}O₂₋ₐF₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiIO₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the formulae above, A may be nickel (Ni), cobalt (Co), manganese (Mn), or a combination thereof; B may be aluminum (Al), nickel (Ni), cobalt (Co), manganese (Mn), chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; E may be cobalt (Co), manganese (Mn), or a combination thereof; F may be fluorine (F), sulfur (S), phosphorus (P), or a combination thereof; G may be aluminum (Al), chromium (Cr), manganese (Mn), iron (Fe), magnesium (Mg), lanthanum (La), cerium (Ce), strontium (Sr), vanadium (V), or a combination thereof; Q may be titanium (Ti), molybdenum (Mo), manganese (Mn), or a combination thereof; I may be selected from chromium (Cr), vanadium (V), iron (Fe), scandium (Sc), yttrium (Y), or a combination thereof; and J may be vanadium (V), chromium (Cr), manganese (Mn), cobalt (Co), nickel (Ni), copper (Cu), or a combination thereof.

The compounds listed above as cathode active materials may have a surface coating layer (hereinafter, also referred to as “coating layer”). In some embodiments of the present disclosure, a mixture of a compound without a coating layer and a compound having a coating layer may be used. In some embodiments, the coating layer may include at least one compound of a coating element selected from the group consisting of an oxide, a hydroxide, an oxyhydroxide, an oxycarbonate, and a hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the cathode active material when a compound of the coating element is used. For example, the coating layer may be formed using spray coating or dipping.

In some embodiments, the cathode active material may be LiCoO₂, LiMnₓO₂ₓ (wherein x=1 or 2), LiNi₁₋ₓMnₓO₂ₓ (wherein 0<x<1), LiNi_{1-x-y}COₓMn_{y}O₂ (wherein 0≤x≤0.5 and 0≤y≤0.5), or LiFePO₄.

Next, an electrolyte may be prepared. For example, the electrolyte may be an organic liquid electrolyte. In some embodiments, the electrolyte may be a solid electrolyte. Examples of the electrolyte may be boron oxide and lithium oxynitride. However, embodiments are not limited thereto. Any material available as a solid electrolyte in the art may be used. In some embodiments, the solid electrolyte may be formed on the anode by, for example, sputtering.

In some embodiments, the organic liquid electrolyte may be prepared, for example, by dissolving a lithium salt in an organic solvent.

The organic solvent may be any solvent that may be used as an organic solvent in the art. For example, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or a mixture thereof.

The lithium salt may be any material that may be used as a lithium salt in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y may each independently be a natural number), LiCl, LiI, or a mixture thereof.

Lithium ion secondary batteries according to the one or more embodiments may be a lithium air battery, a lithium oxide battery, a lithium all-solid state battery, or the like.

In a stack-type lithium ion secondary battery, a gap may be between an electrode and a separation membrane. However, the lithium ion secondary battery according to one or more embodiments may not include a gap between an electrode and the separation membrane, and thus have reduced internal resistance and improved cell performance, for example, in terms of high-rate characteristics.

When the stack-type lithium ion secondary battery is manufactured by dry heat lamination, the dry heat lamination may be performed at a temperature of about 100° C. to about 150° C., for example, about 110° C. to about 130° C., at a pressure of about 0.3 MPa to about 5 MPa, for example, about 0.5 MPa to about 1.5 MPa, for about 0.1 minute to about 30 minutes, for example, about 1 minute to about 8 minutes. In some embodiments, the separation membrane may have a porous structure due to the cellulose nanofibers, wherein the micropores may remain unclogged even after the dry heat lamination.

In some embodiments, a plurality of battery assemblies may be stacked to form a battery pack, which may be used in any device that requires high capacity and high output, for example, in a laptop computer, a smartphone, or an electric vehicle.

The lithium ion secondary battery according to the one or more embodiments may have improved high-rate characteristics and lifetime characteristics, and thus may be may be used in an electric vehicle (EV), for example, in a hybrid vehicle such as a plug-in hybrid electric vehicle (PHEV), an E-bike, an E-scoopter, or an electric gold cart, or a power storage system.

One or more embodiments of the present disclosure will now be described in detail with reference to the following examples. However, these examples are only for illustrative purposes and are not intended to limit the scope of the one or more embodiments of the present disclosure.

### Example 1

About 0.40 wt % of cellulose nanofibers having an average fiber diameter of about 50 nm, about 0.005 wt % of POVAL as a binder (a vinyl alcohol-vinyl acetate copolymer having an average polymerization degree of 1400 and a saponification degree of 99%, available from Showa Chemical Industry Co., Ltd.), and about 1.0 wt % of triethylene glycol butyl methyl ether (Hisolve BTM, Toho Chemical Industry Co.) were diluted with ion-exchanged distilled water and then stirred to prepare a suspension of the cellulose nanofibers.

This suspension was cast onto an artificial graphite anode, which was fixed to a PET film, coated thereon with a film applicator, and then dried in a drying furnace to remove the aqueous dispersion medium and triethylene glycol butyl methyl ether, thereby obtaining a separation membrane-integrated electrode assembly. About 80 wt % of the cellulose nanofibers in the separation membrane-integrated electrode assembly had a fiber diameter of less than 1000 nm.

Hereinafter, physical property measurement methods of the separation membrane-integrated electrode assembly of Example 1, the separation membrane-integrated electrode assemblies of Examples 2 to 8, and a nonwoven fabric separation membrane of Comparative Example 1, are described.

Thicknesses of the separation membrane-integrated electrode assemblies of Examples 1 to 8 and the nonwoven fabric separation membrane of Comparative Example 1 were measured using a micrometer.

A volume density of each binder was calculated in the following manner. Each binder solution was cast onto a polytetrafluoroethylene (PTFE) dish such that about 1 g or more of the polymer resin used as the binder was contained in the PTFE dish, and then subjected to natural drying in a 25° C. thermostatic chamber under static conditions over 3 days. The dried product was then heated on a hot plate at 95° C. to remove the solvent. A polymer binder weight was obtained by subtracting the weight of the PTFE dish from a total weight of the dried product. Subsequently, a polymer binder volume was obtained by pouring water into the PTFE dish containing the polymer binder to measure a volume of the remaining dish space, and then subtracting the measured volume from the volume of the empty dish. A volume density of the polymer resin was then calculated by dividing the polymer binder weight by the polymer binder volume. An average volume density of the polymer resin was determined from three measurements (N=3).

The thickness of the cellulose nanofiber layer (a separation membrane including the cellulose nanofiber layer) was calculated by subtracting the thickness of the graphite anode from the thickness of the separation membrane-integrated electrode assembly, and was found to be about 18 μm. As a result of conversion based on a density of about 1.50 g/cc (gram per cubic centimeter) of the cellulose nanofibers, an average density of about 1.25 g/cc of POVAL, and an increased weight with respect the original graphite anode, porosity was about 71%.

The cathode of test batteries includes lithium nickel cobalt aluminum oxide (LiNi_{0.85}Co_{0.14}Al_{0.01}O₂), and the anode of test batteries includes artificial graphite. In Example 1, a laminate cell was manufactured in the thermostatic chamber set at a temperature of 25° C. using the separation membrane-integrated electrode assembly.

A 180°-peel test was performed using the laminate cell manufactured in Example 1. As a result, peeling occurred at the interface between the anode current collector and the anode active material layer, and a peel strength was about 1.6 kgf/cm². It was found from this result that the interface between the anode active material layer and the separation membrane including the cellulose nanofibers had a high binding strength.

### Example 2

About 0.40 wt % of cellulose nanofibers having an average fiber diameter of about 50 nm, about 0.005 wt % of POVAL as a binder (a vinyl alcohol-vinyl acetate copolymer having an average polymerization degree of 1400 and a saponification degree of 99%, available from Wako Pure Chemical Industries, Ltd.), and about 1.0 wt % of triethylene glycol butyl methyl ether (Hisolve BTM, Toho Chemical Industry Co.) were diluted with ion-exchanged distilled water and then stirred to prepare a suspension of the cellulose nanofibers.

This suspension was cast onto an artificial graphite anode, which was fixed to a PET film, coated thereon with a film applicator, and then dried in a drying furnace to remove the aqueous dispersion medium and triethylene glycol butyl methyl ether, thereby obtaining a separation membrane-integrated electrode assembly.

As a result of subtracting the thickness of the original graphite anode from the thickness of the separation membrane-integrated electrode assembly, the thickness of the cellulose nanofiber layer was found to be about 18 μm. Using the conversion method as detailed in Example 1, a porosity was found to be about 68%.

### Example 3

About 0.40 wt % of cellulose nanofibers having an average fiber diameter of about 50 nm, about 0.007 wt % of poly-N-vinylcarboxylic acid amide (GE191-103, available from Showa Denko), about 1.0 wt % of propylene carbonate (Kishida Chemical Co., Ltd, battery grade), and about 0.1 wt % of methanol (Kishida Chemical Co., Ltd, extra fine grade) were diluted with ion-exchanged distilled water and then stirred to prepare a suspension of the cellulose nanofibers.

This suspension was cast onto an artificial graphite anode which was fixed to a PET film, coated thereon with a film applicator, and then dried in a drying furnace to remove the aqueous dispersion medium, propyl carbonate, and methanol to thereby obtain a separation membrane-integrated electrode assembly.

As a result of subtracting the thickness of the graphite anode from the thickness of the separation membrane-integrated electrode assembly, the thickness of the cellulose nanofiber was found to be about 18 μm. As a result of the conversion method as detailed in Example 1, based on a density of about 1.19 g/cc of the poly-N-vinylcarboxylic acid amide, a porosity was found to be about 70%.

### Example 4

About 0.40 wt % of cellulose nanofibers having an average fiber diameter of about 50 nm, about 0.006 wt % of modified polyacrylic acid (LSR-7, an N-methyl-2-pyrrolidone solution with 6 wt % of a solid content, available from Hitachi Chemical), and about 0.59 wt % of propylene carbonate (Kishida Chemical Co., Ltd, battery grade) were diluted with ion-exchanged distilled water and then stirred to prepare a suspension of the cellulose nanofibers.

This suspension was cast onto an artificial graphite anode, which was fixed to a PET film, coated thereon with a film applicator, and then dried in a drying furnace to remove the aqueous dispersion medium and propylene carbonate to thereby obtain a separation membrane-integrated electrode assembly.

As a result of subtracting the thickness of the graphite anode from the thickness of the separation membrane-integrated electrode assembly, the thickness of the cellulose nanofiber layer was found to be about 18 μm. Using the conversion method as detailed in Example 1, based on a density of about 1.18 g/cc of the modified polyacrylic acid, a porosity was found to be about 70%.

### Example 5

About 0.40 wt % of cellulose nanofibers having an average fiber diameter of about 50 nm, about 0.002 wt % of modified POVAL (Nippon Kosei Chemical Co., GOHSENX Z-410, a vinyl alcohol-vinyl acetate copolymer having a saponification degree of about 98%), and about 11.0 wt % of triethylene glycol butyl methyl ether (Hisolve BTM, Toho Chemical Industry Co.) were diluted with ion-exchanged distilled water and then stirred to prepare a suspension of the cellulose nanofibers.

This suspension was cast onto an artificial graphite anode, which was fixed to a PET film, coated thereon with a film applicator, and then dried in a drying furnace to remove the aqueous dispersion medium and triethylene glycol butyl methyl ether, thereby obtaining a separation membrane-integrated electrode assembly.

As a result of subtracting the thickness of the graphite anode from the thickness of the separation membrane-integrated electrode assembly, the thickness of the cellulose nanofiber layer was found to be about 18 μm. Using the conversion method as detailed in Example 1, based on a density of about 1.23 g/cc of the modified POVAL, a porosity was found to be about 72%.

### Example 6

A separation membrane-integrated electrode assembly was obtained in the same manner as in Example 2, except that the amount of POVAL (binder) was controlled to be 0.5-fold with respect to 100 parts by weight of the cellulose nanofibers. The cellulose nanofiber layer had a thickness of about 19 m and a porosity of about 77%.

### Example 7

A separation membrane-integrated electrode assembly was obtained in the same manner as in Example 1, except that the amount of POVAL (binder) was controlled to be 3.0-fold with respect to 100 parts by weight of the cellulose nanofibers. The cellulose nanofiber layer had a thickness of about 19 m and a porosity of about 53%.

### Example 8

A separation membrane-integrated electrode assembly including a porous insulating layer between the separation membrane including the cellulose nanofiber layer and the electrode active material layer was obtained as follows. The porous insulating layer was formed by mixing high-purity alumina having a median particle diameter of about 0.7 μm (KP-3000, Sumitomo Chemicals) and a modified acrylonitrile rubber particle binder (BM-520B, Zeon Corporation, Japan) in a weight ratio of about 95:5 to prepare a filler solution, coating the filler solution on an artificial graphite anode, and drying a resulting product. Then, as described in Example 1, the suspension of the cellulose nanofibers was coated on the resulting product and then dried.

To form a porous insulating layer using an inorganic filler, the filler used above may be replaced with a metal hydroxide such as aluminum hydroxide having an average particle diameter of about 0.8 μm (H-43M, Showa Denko).

To form a porous insulating layer using a heat-resistant organic filler, the filler used above may be replaced with cross-linked acrylic monodisperse particles (MX-80 H3wT, Soken Chemical Co.).

### Comparative Example 1

After the preparation of the suspension of the cellulose nanofibers as described in Example 1, the suspension of the cellulose nanofibers was cast onto a PET film, coated with a film applicator, and then dried to thereby form a cellulose nanofiber-nonwoven fabric membrane.

The air permeability of the cellulose nanofiber-nonwoven fabric membrane was measured using a Gurley type densometer (Toyo Seiki Co., Ltd.), according to JISP8117. The time it took for 100 cc of air to pass through, a test specimen fixed in close contact with a circular hole having an outer diameter of about 28.6 mm was measured. The cellulose nanofiber-nonwoven fabric membrane had a thickness of about 18 μm. As a result of conversion based on a density of about 1.50 g/cc of the cellulose nanofibers and an average density of about 1.25 g/cc of POVAL, a porosity of the cellulose nanofiber-nonwoven fabric membrane was about 74%. The cellulose nanofiber-nonwoven fabric membrane had an air permeability of about 365 sec/100 cc.

### Comparative Example 2

A suspension of the cellulose nanofibers was prepared in the same manner as in Example 1, except that POVAL (binder) was not added. This suspension was cast onto an artificial graphite anode fixed to a PET film, coated thereon with a film applicator, and then dried in a drying furnace to remove the aqueous dispersion medium and triethylene glycol butyl methyl ether. However, after the drying, the separation membrane had completely peeled off from the artificial graphite anode, such that it was not possible to form a separation membrane-integrated anode.

The mixing weight ratios of the cellulose nanofibers to the binder in Examples 1 to 6 are represented in Table 1.

TABLE 1

| Example | Mixing weight ratio of cellulose nanofibers and binder |
|---|---|
| Example 1 | 100:1.25 |
| Example 2 | 100:1.25 |
| Example 3 | 100:1.75 |
| Example 4 | 100:0.75 |
| Example 5 | 100:0.5 |
| Example 6 | 100:0.5 |

### Evaluation Example 1: Rapid-Charging Cycle Test

Rapid-charging cycle characteristics were evaluated using test batteries. Each test battery used lithium nickel cobalt aluminum oxide (LiNi_{0.85}Co_{0.14}Al_{0.01}O₂) as the cathode and artificial graphite as the anode.

In the test batteries of Examples 1 to 7, the separation membrane-integrated electrode assembly was used as the anode. The cathode and the separation membrane-integrated anode were stacked on one another, dry heat laminated by heating at about 120° C. at a pressure of about 1 MPa for about 5 minutes, thereby forming a laminate cell. The laminate cell was placed in a thermostatic chamber set at a temperature of 25° C.

After a formation process through charging and discharging (4.35 V to 2.8V) at a 10-hour rate, 100 cycles of constant current charging (3 C charging) at a ⅓-hour rate and constant current discharging (0.5 C discharging) at a 2-hour rate were performed. A ratio of discharge capacity at the 100^{th} cycle to initial discharge capacity (assumed as 100) at the 1^{st} cycle was evaluated as a capacity retention. Capacity retentions of the batteries manufactured in Examples 1 to 7 and Comparative Example 1 were evaluated. The results are shown in Table 2 and FIG. 2.

TABLE 2

| Example | Capacity retention (@100cycle) |
|---|---|
| Example 1 | 89 |
| Example 2 | 94 |
| Example 3 | 92 |
| Example 4 | 95 |
| Example 5 | 94 |
| Example 6 | 92 |
| Example 7 | 85 |
| Comparative | 83 |
| Example 1 | |

Referring to Table 2 and FIG. 2, the batteries of Examples 1 to 7 were found to have improved capacity retentions after rapid charging, compared to the battery of Comparative Example 1.

### Evaluation Example 2: Current Resistance Before and after Cycle

After the batteries manufactured according to Example 1, Example 6, and Comparative Example 1 were charged with a constant current to 50% of SOC (state of charge) at a 2-hour rate (0.5 C), the batteries were immediately discharged with 2 C (2.8V) without a rest period (2 C, 2.8V).

The resistance of each battery at 25° C. at a battery voltage after 1 second of discharging was calculated based on Ohm's law. The results are shown in Table 3.

TABLE 3

| | Initial resistance | Resistance after | Resistance increase |
|---|---|---|---|
| Example | (Ω) | test (Ω) | ratio (%) |
| Example 1 | 0.139 | 0.146 | 5 |
| Example 6 | 0.087 | 0.091 | 5 |
| Comparative | 0.192 | 0.229 | 20 |
| Example 1 | | | |

Referring to Table 3, the batteries of Examples 1 and 6 were found to have reduced resistance increase ratios, compared to the battery of Comparative Example 1.

### Evaluation Example 3: High-Rate Characteristics

Capacities of the batteries manufactured in Example 1, Example 6, and Comparative Example 1 after charging at constant currents of 1 C, 3 C, and 6 C until a voltage of 4.3V was reached were compared. Discharging was then performed (0.5 C, 2.8V, and 25° C.).

The capacities of each battery at 3 C and 5 C relative to the capacity (assumed as 100) of the each battery after the charging at 1 C (4.3V) are shown in Table 4.

TABLE 4

| Example | 1 C | 3 C | 5 C |
|---|---|---|---|
| Example 1 | 100 | 90 | 76 |
| Example 6 | 100 | 91 | 75 |
| Comparative | 100 | 87 | 59 |
| Example 1 | | | |

Referring to Table 4, the batteries of Example 1 and Example 6 were found to have improved high-rate characteristics, compared to the battery of Comparative Example 1.

### Evaluation Example 4: Scanning Electron Microscopy (SEM)

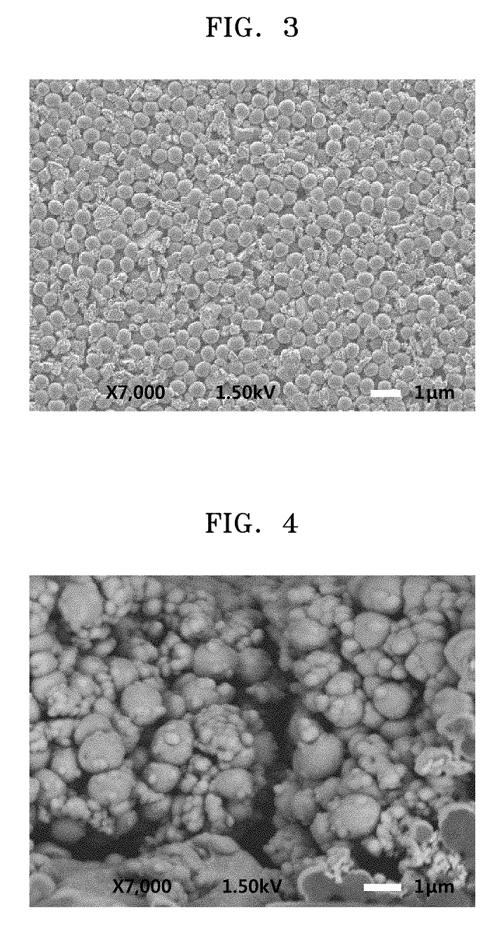

A cross-section of the separation membrane-integrated anode assembly in the laminate cell manufactured in Example 1 was analyzed using scanning electron microscopy (SEM). The results are shown in FIGS. 3 and 4.

Referring to FIGS. 3 and 4, it was found that micropores still remained after the heat lamination due to the porous structure formed by the cellulose nanofibers.

The above-described examples are merely exemplary, and the present disclosure is not limited thereto. The above-described examples may be modified by combination or partial substitution with well-known or general technologies. Examples which will be obvious to one of ordinary skill in the art may also be incorporated into the present disclosure.

As described above, according to the one or more embodiments, a separation membrane-integrated electrode assembly for a lithium ion secondary battery may have strong binding strength between the electrode and the separation membrane since the separation membrane having high heat-resistance is fixed to the electrode, such that a gap may be not formed between the electrode and the separation membrane. Therefore, a lithium ion secondary battery having improved rapid charging characteristics and lifetime characteristics may be manufactured using the separation membrane-integrated electrode battery.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosed subject matter and does not pose a limitation on the scope of the disclosure unless otherwise claimed. No language in the specification should be construed as indicating any non-claimed element as essential to the practice of the subject matter disclosed herein.

Embodiments are described herein, including the best mode of operation. Variations of those embodiments may become apparent to those of ordinary skill in the art upon reading the foregoing description, and such variations are contemplated by applicant. Accordingly, disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A separation membrane-integrated electrode assembly for a lithium ion secondary battery, the assembly comprising:
an electrode active material layer; and
a separation membrane on the electrode active material layer, wherein the separation membrane comprises cellulose nanofibers and a polymer, and the polymer is a water-soluble or water dispersible polymer.

2. The separation membrane-integrated electrode assembly of claim 1, wherein the separation membrane comprises about 80 parts by weight to about 99 parts by weight cellulose nanofibers based on 100 parts by weight of the total weight of the separation membrane, and the cellulose nanofibers have an average fiber diameter of about 10 nm to about 2000 nm.

3. The separation membrane-integrated electrode assembly of claim 1, wherein the polymer contains a reactive group that forms a hydrogen bond with the cellulose nanofibers, and the polymer is a polymer having a main chain containing a hydroxyl group, a polymer having a side chain containing at least one selected from a hydroxyl group, —CO, —COO, —COOH, —CN, and —NH₂, or a combination thereof.

4. The separation membrane-integrated electrode assembly of claim 1, wherein the polymer comprises:
at least one polymer selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide;
at least one copolymer comprising at least two selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide; or a combination thereof.

5. The separation membrane-integrated electrode assembly of claim 1, wherein less than about 20 wt % of the cellulose nanofibers have an average fiber diameter of about 1000 nm or greater.

6. The separation membrane-integrated electrode assembly of claim 1, further comprising a porous insulating layer between the separation membrane and the electrode active material layer.

7. The separation membrane-integrated electrode assembly of claim 6, wherein the porous insulating layer comprises a heat-resistant filler as a main component.

8. The separation membrane-integrated electrode assembly of claim 7, wherein the heat-resistant filler comprises inorganic particles.

9. The separation membrane-integrated electrode assembly of claim 8, wherein the inorganic particles comprise a metal hydroxide, a metal oxide, a metal carbonate, a metal sulfate, a clay mineral, or a combination thereof.

10. The separation membrane-integrated electrode assembly of claim 7, wherein the heat-resistant filler comprises heat-resistant organic particles.

11. The separation membrane-integrated electrode assembly of claim 10, wherein the heat-resistant organic particles comprise crosslinked polymer particles, heat-resistant polymer particles, or a combination thereof.

12. A lithium ion secondary battery comprising the separation membrane-integrated electrode assembly of claim 1.

13. A method of manufacturing a separation membrane-integrated electrode assembly for a lithium ion secondary battery, the method comprising:
coating an electrode active material layer with a composition comprising cellulose nanofibers, an aqueous polymer, a water-soluble organic solvent, and water, to thereby form a separation membrane; and
drying the separation membrane,
wherein the aqueous polymer is a water-soluble or water-dispersible polymer.

14. The method of claim 13, wherein the separation membrane comprises about 80 parts by weight to about 99 parts by weight cellulose nanofibers based on 100 parts by weight of the total weight of the separation membrane, and the cellulose nanofibers have an average fiber diameter of about 10 nm to about 2000 nm.

15. The method of claim 13, wherein the water-soluble organic solvent comprises at least one selected from an alcohol-containing organic solvent, a lactone-containing organic solvent, a glycol-containing organic solvent, a glycol ether-containing organic solvent, glycerin, a carbonate-containing organic solvent, and N-methylpyrrolidone, and
an amount of the water-soluble organic solvent is about 5 parts by weight or greater with respect to 100 parts by weight of the cellulose nanofibers.

16. The method of claim 13, wherein the water-soluble organic solvent comprises at least one selected from 1,5-pentanediol, 1-methylamino-2,3-propanediol, ε-caprolactone, α-acetyl-γ-butyrolactone, diethylene glycol, 1,3-butylene glycol, propylene glycol, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, diethylene glycol diethyl ether, glycerin, propylene carbonate, ethylene carbonate, and N-methylpyrrolidone.

17. The method of claim 13, wherein the aqueous polymer comprises at least one polymer selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide;
at least one copolymer comprising at least two selected from polyvinyl alcohol, polyvinyl acetate, polyacrylic acid, polyacrylic acid ester, polymethacrylic acid, polymethacrylic acid ester, poly-N-vinylcarboxylic acid amide, polyacrylonitrile, polyether, and polyamide; or a combination thereof.

18. The method of claim 13, wherein less than about 20 wt % of the cellulose nanofibers have an average fiber diameter of about 1000 nm or greater.

19. The method of claim 13, further comprising, before the forming of the separation membrane, forming a porous insulating layer on the electrode active material layer, the porous insulating layer comprising a heat-resistant filler as a main component, and then forming the separation membrane over the porous insulating layer.

20. The method of claim 19, wherein the heat-resistant filler comprises inorganic particles or heat-resistant organic particles.

21. The method of claim 20, wherein the inorganic particles comprise a metal hydroxide, a metal oxide, a metal carbonate, a metal sulfate, a clay mineral, or a combination thereof, and
the heat-resistant organic particles comprise crosslinked polymer particles, heat-resistant polymer particles, or a combination thereof.
